(19) United States
(12) Patent Application Publication
(10) Pub. No.: US 2023/0047394 A1
(43) Pub. Date: Feb. 16, 2023

(54) APPARATUS FOR THE TREATMENT OF CONTAINERS WITH SUPPORTED CLEAN ROOM

(71) Applicant: KRONES AG, Neutraubling (DE)

(72) Inventors: Waldemar SUPPES, Nittendorf (DE); Christian WITTMANN, Hemau (DE); Florian GERNGROSS, Regensburg (DE); Daniel THEEN, Lappersdorf (DE); Florian GELTINGER, Donaustauf (DE); Daniel PETER, Hemau (DE)

(21) Appl. No.: 17/820,173

(22) Filed: Aug. 16, 2022

(30) Foreign Application Priority Data
Aug. 16, 2021 (DE) 10 2021 121 177.8

(51) Int. Cl. B29C 49/46; B67C 3/24; B29C 49/42

(52) U.S. Cl. CPC B29C 49/46; B67C 3/24; B29C 49/42095; B67C 2003/228

(57) ABSTRACT

Apparatus for treating containers has a transport device which transports the containers at least in sections along a predetermined transport path, and a plurality of treatment devices which treat the containers at least at times during transport along the transport path, wherein the apparatus has a clean room which clean room is delimited from an environment by at least one wall, and furthermore at least one sealing device is provided for sealing off the clean room from its environment, wherein this sealing device has at least two elements and/or walls which can be moved with respect to one another wherein, the clean room is formed between a floor unit and a ceiling unit and at least the floor unit or the ceiling unit is formed as a load-bearing unit and support elements are arranged within the clean room for supporting the ceiling unit and/or the floor unit.

### BACKGROUND OF THE INVENTION

The present invention relates to an apparatus and a method for treating containers. Various apparatus and methods for treating containers are known from the prior art. For example, filling devices are known which fill containers or also forming machines such as, for example, blow moulding machines which form plastic preforms into plastic containers. The present invention is described with particular reference to such blow moulding machines.

In recent times, it has become known to design such machines as blow moulding machines but also filling machines in a sterile manner. This means that the treatment of the containers, such as filling or the blow moulding of plastic preforms into plastic bottles, takes place in a clean room, wherein this clean room is a sterile room that is shielded from a (non-sterile) environment. For this purpose, a high expenditure of walls and supporting elements is sometimes necessary. Another problem is that such a clean room should be easily accessible after a sterilisation process. At the same time, however, a high degree of stability of the clean room and the arrangement therein should also be possible.

EP 2 504 244 B1 describes an apparatus, in particular a filling machine, which has such a clean room. In this publication, it is proposed to arrange load-bearing elements outside the clean room in the manner of a scaffold. This approach leads to satisfactory stability, but has the disadvantage that the machine is comparatively difficult to access, since the scaffold-like structure impedes free access to the machine. In addition, such an external scaffolding structure gives the machine the appearance of an improvised installation.

### SUMMARY OF THE INVENTION

Based on the prior art, the skilled person is therefore faced with the object of manufacturing such machines with a clean room which, on the one hand, enable a high degree of stability, but, on the other hand, do not significantly impair access to the machine. According to the invention, this is achieved by an apparatus according to the independent patent claims. Advantageous embodiments and further developments are the subject matter of the subclaims.

An apparatus according to the invention for treating containers has a transport device which transports the containers at least in sections along a predetermined transport path. Furthermore, a plurality of treatment devices and/or treatment stations is provided which treat the containers at least temporarily during transport along the transport path (and in particular at least temporarily while they are in motion). Preferably, the at least one treatment device is arranged on the transport device and is preferably moved and/or transported by this transport device.

Furthermore, the apparatus comprises a clean room within which the containers are transported during their treatment, wherein this clean room being delimited from an environment by means of at least one wall (and preferably by means of a plurality of walls), and furthermore a sealing device is provided for sealing the clean room from its environment, wherein this sealing device comprising at least two elements and/or walls which are movable relative to one another.

According to the invention, the clean room is formed between a floor unit and a ceiling unit and at least the floor unit and/or the ceiling unit is formed as a load-bearing unit and furthermore support elements for supporting the ceiling unit and/or the floor unit (and/or the ceiling unit with respect to the floor unit) are arranged within the clean room.

In contrast to the described prior art, it is therefore proposed that there is a floor of the clean room and a lid or ceiling device of the clean room, which are themselves designed as load-bearing elements and which, as described in detail below, are also particularly suitable for supporting the sealing device.

In a preferred embodiment, the sealing device or components of the sealing device are therefore integrated into the floor unit and/or the ceiling device.

Furthermore, in contrast to the prior art arrangement described above, support elements of the cleanroom, and in particular load-bearing support elements, are arranged inside the cleanroom. In this way, the load-bearing structures of the cleanroom can be arranged behind walls that delimit the cleanroom and are therefore not visible to the user.

Advantageously, the apparatus is a blow moulding machine or a filling machine and in particular a blow moulding machine. Preferably, the blow moulding machine is a stretch blow moulding machine. Preferably, the individual treatment stations each have blow mould carriers and blow moulds, as well as blow nozzles which can be applied to the plastic preforms in order to expand them. In addition, these forming stations preferably also have stretching rods which can be inserted into the plastic preforms in order to stretch them in their longitudinal direction.

It is possible and preferred that a mechanism and/or drives, for example for moving the stretching bars themselves, are arranged outside the clean room.

Particularly preferably, this clean room is ring-shaped and/or in the form of a torus and especially a torus with straight walls. In this way, the size of a clean room can be reduced. Preferably, for example, the containers are transported inside the clean room, but an axis of rotation of the transport device and/or areas of the transport device, such as a blowing wheel, are located outside the clean room.

Particularly preferably, the sealing device is a hydraulic sealing device and in particular a so-called water lock. This water lock can have a circumferential channel filled with a fluid and a movable part of the arrangement can be guided in this fluid (in particular in the manner of a sword) in order to achieve mobility in this way, but on the other hand a hydraulic seal.

Particularly preferably, the sealing device has two sealing devices or two such water locks or hydraulic seals. The cross-sections of the channels in which the liquid is guided can be of different sizes. Particularly preferably, a lower sealing device is provided, which is essentially below the transport path of the containers (and/or the forming stations), as well as an upper sealing device, which is preferably above the transport path of the containers (and/or the forming stations).

The present invention is further directed to an apparatus for treating containers, which has a circular or part-circular transport path formed by a transport device, on which the containers are moved at least with a respective partial region having a container opening within a sterile clean room delimited from the surroundings by an enclosure. A subsection of this enclosure is on the transport device and is moved along with it, and a further subsection of the enclosure is provided on the apparatus frame of the apparatus which is not moved along with the transport device.

Furthermore, at least in the further subsection, the enclosure consists of a wall structure formed by wall elements, which delimits the clean room of the wall structure of the enclosure towards the surroundings. Furthermore, a load-bearing structure is provided, wherein the elements of the load-bearing structure comprise a plurality of carriers oriented transversely or perpendicularly to a transport direction of the transport device, which beams are attached at one end with mechanical connections. Furthermore, labyrinth and/or siphon seals are provided at the transition between the subsections and the clean room is formed between a floor unit and a ceiling unit and at least the floor unit and/or the ceiling unit are formed as load-bearing elements (of the load-bearing structure) and within the clean room supporting elements (of the load-bearing structure) are arranged for supporting the ceiling unit and/or the floor unit.

In a further preferred embodiment, at least one sealing device has a circumferential channel which can be filled with a liquid, wherein this channel being formed in the ceiling unit. In a further preferred embodiment, the apparatus has at least one sealing device with at least one circumferential channel that can be filled with a liquid, wherein this channel being formed in the floor unit.

Preferably, such a circumferential channel is formed in both the ceiling unit and the floor unit. This means that the ceiling unit and/or the floor unit are formed as load-bearing units in that they are able to support said channel, including a liquid located in said channel.

Particularly preferably, a sword or an immersion means is provided on the rotating part, i.e. the part of the transport device that rotates, which immerses into the channel and in particular the liquid located there. For example, this sword can be provided on a rotatable carrier on which the forming stations are arranged.

In a further preferred embodiment, the floor unit and/or the ceiling unit has a wall thickness that is at least 4 mm, preferably at least 5 mm and particularly preferably at least 6 mm. Sufficient stability of the floor unit and/or the ceiling unit can be achieved by these wall thick-nesses. The floor unit and/or ceiling unit is at least also capable of supporting the sealing device or the circumferential channel.

In a further preferred embodiment, a section of the floor unit is also a section of the channel. Thus, the channel can be formed in that vertically (or also obliquely) running (in particular parallel) walls are formed on the floor unit, between which a liquid can be arranged. However, it would also be possible for the channel to be formed independently, for example U-shaped or V-shaped and arranged on the floor unit and/or the ceiling unit, for example welded to the latter. In this way, too, the stability of the floor unit and/or the ceiling unit can be increased.

Particularly preferably, the floor unit and/or the ceiling unit has a wall thickness that is less than 30 mm, preferably less than 25 mm, preferably less than 20 mm, preferably less than 15 mm and preferably less than 10 mm. By these delimitations it is achieved that the weight of the floor and/or ceiling unit does not become excessively high. Thus, it is essential to find a compromise between a sufficient wall thickness of the floor and/or ceiling unit on the one hand and a still comparably low weight (and also lower manufacturing costs) on the other hand.

In a further preferred embodiment, the support elements are column elements that connect the floor unit to the ceiling unit. Preferably, these columns cause the floor unit and the ceiling unit to be positioned within the clean room via a positive connection.

Preferably, these column elements are arranged at an edge of the cleanroom and can also be arranged or attached, for example, to wall elements described in more detail below. In this way, the column elements do not impair the hygienic concept of the cleanroom, or only to a minor extent. On the other hand, suitable positioning of the column elements, for example at corners of the cleanroom, can ensure that the cleanroom is accessible in an even more advantageous manner. Preferably, these column elements are designed as hollow profiles.

In a further preferred embodiment, the clean room is also delimited by side walls, wherein these side walls are preferably non-load-bearing. In this case, it is possible to use comparatively thin metal sheets to form the side walls. Preferably, the floor unit and/or the ceiling unit are also made of metal sheets, for example steel sheets. The side walls can be attached to the support elements, for example.

Thereby, these side walls can have a wall thickness that is less than 6 mm, preferably less than 5 mm, preferably less than 4 mm and particularly preferably less than 3 mm.

It would also be possible for the side walls to be attached to each other. Particularly preferably, at least one of these side walls and several side walls have openings. These openings can, for example, serve as airlocks for the insertion of plastic preforms or for the removal of containers. In addition, the openings can also be inspection openings which allow work to be carried out inside the clean room. Furthermore, these openings can also serve external units, for example for robot arms, which are suitable and intended for the exchange of blow moulds or filling elements.

In a further preferred embodiment, the apparatus has a base support on which the floor unit is arranged. The floor unit can be attached to this base support, for example, by means of further support elements.

In a further preferred embodiment, the apparatus has at least one crossbar and in particular a supporting crossbar. This support crossbar can, for example, extend in a horizontal direction. Advantageously, two or more such support crossbars are provided. Further elements can be attached to these crossbars, such as ventilation units, horizontal bar movement units and the like. Preferably, this support crossbar connects at least two support elements to each other.

In a further preferred embodiment, it is also possible that such a frame crossbar also serves to support or transport the entire apparatus. In the prior art, external frame crossbars were sometimes lifted at the bottom of the supporting platform. However, such frame crossbars are relatively complex and expensive and usually have to be shipped separately and then searched for and moved again on a construction site.

It is therefore proposed in this embodiment that a crossbar construction and in particular a welded construction is integrated into the machine structure. At the same time, this load-bearing construction or this crossbar can enable load-bearing tasks for further machine functions such as a blowing nozzle cam carrier, a support for the ceiling unit or also a mounting for ventilation technology. In this way, functional integration is achieved, which in turn leads to cost savings.

The applicant reserves the right to independently claim protection on this design with the crossbars. This means that the crossbar described here can also be claimed independently of the design of the clean room with its support elements.

Preferably, the support crossbeam(s) is/are located outside the clean room. Preferably, the support crossbeam(s) provides a mechanical (at least indirect) connection between two support elements.

Thus, in a further advantageous embodiment, the support crossbeam also serves to support further units of the apparatus, wherein these further units preferably being selected from a group of units comprising guide cams, blowing cams, carrier, ceiling supports, ventilation elements and the like.

### BRIEF DESCRIPTION OF THE DRAWINGS

Further embodiments and advantageous designs can be seen in the attached drawings:

In the drawings:

FIG. 1 shows a rough schematic representation of an apparatus for treating containers;

FIG. 2 shows an illustration of a clean room construction for the present invention;

FIG. 3 shows a representation of a floor unit;

FIG. 4 shows a representation of the floor unit with support elements;

FIG. 5 shows a representation of the ceiling unit from below;

FIG. 6 shows a top view of the ceiling unit;

FIG. 7 shows a composition of the floor unit and the ceiling unit;

FIG. 8 shows a representation of the clean room with walls;

FIG. 9, 10 show two illustrations to show the support of the clean room against a support frame;

FIG. 11 shows a further illustration to illustrate the present invention, and;

FIG. 12 shows a further illustration to illustrate the invention.

### DETAILED DESCRIPTION OF THE INVENTION

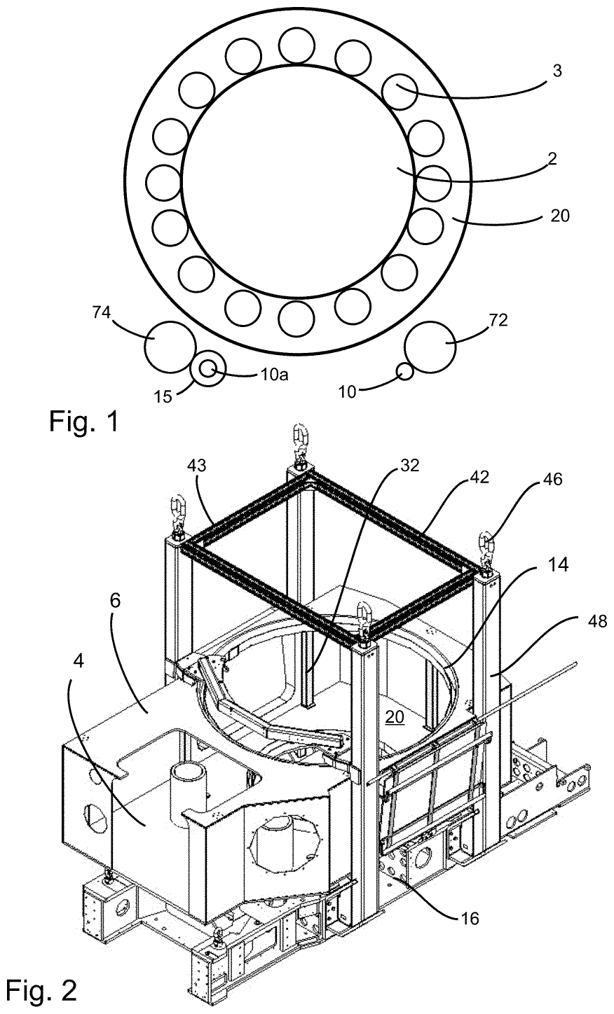

FIG. 1 shows a rough schematic representation of an apparatus 1 for treating containers according to the invention. In this case, plastic preforms 10 are fed to the system and expanded into plastic bottles or generally plastic containers 15 by means of a plurality of forming stations 3. The reference sign 10a indicates a mouth of the plastic containers which does not change or is not expanded during the forming process.

The reference sign 20 indicates a clean room, which is formed here between the two circular lines and within which the treatment of the containers takes place. The reference sign 72 indicates a feed device, such as a transport starwheel, which feeds the plastic preforms 10 to the apparatus, and the reference sign 74 indicates a removal device, preferably also a transport starwheel, which removes the manufactured plastic containers from the device.

FIG. 2 shows an illustration explaining a cleanroom 20 according to the invention. Here, reference sign 4 refers to a floor unit and reference sign 6 refers to a ceiling unit. As mentioned above, these two units are preferably designed as load-bearing elements and delimit the clean room 20 downwards and upwards. Reference sign 14 denotes a sealing device formed in the ceiling unit 6, which serves to seal the clean room from the environment. A circumferential channel is formed here, within which a liquid can be guided. The reference sign 32 indicates a support element which supports the ceiling unit 6 relative to the floor unit 4. This support element runs inside the clean room. It can be seen that a plurality of such support elements are provided.

The reference sign 48 indicates a longitudinal support which also extends in a vertical direction and which is preferably arranged outside the clean room. Two crossbars 42, 43 and also other crossbars are provided on these longitudinal supports 48. These crossbars form a rec-tangle here. The reference sign 46 indicates a carrying means by means of which the entire apparatus can be lifted and transported.

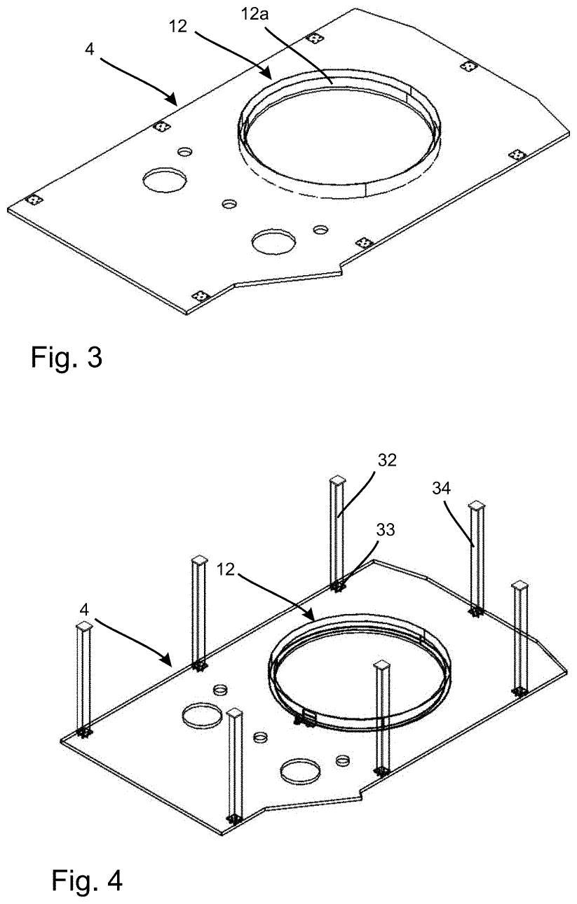

FIG. 3 shows an illustration of the floor unit 4. Here again the sealing device 12 and more precisely the circumferential channel 12a is provided, which is formed in the floor unit 4. Since the floor unit is designed as a load-bearing unit, it is also able to support the channel and also a channel filled with liquid without bending.

In the illustration shown in FIG. 4, support elements 32 and 34 are arranged on the floor unit by means of connecting elements 33. These connecting elements can be screw elements in particular, but welding is also possible.

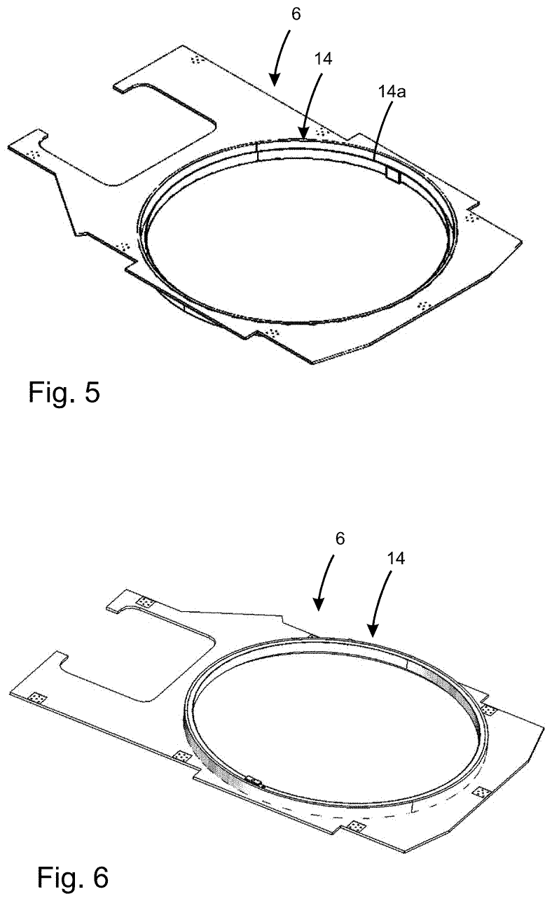

FIG. 5 shows a top view of the ceiling unit. Here again, a sealing device 14 is provided, which accordingly has a circumferential channel 14a.

FIG. 6 shows a view of the ceiling unit from below, wherein again showing the sealing device, which is part of a water lock. The cross-section of the circumferential channel of the sealing device 14 is larger than the cross-section of the circumferential channel of the sealing device 12.

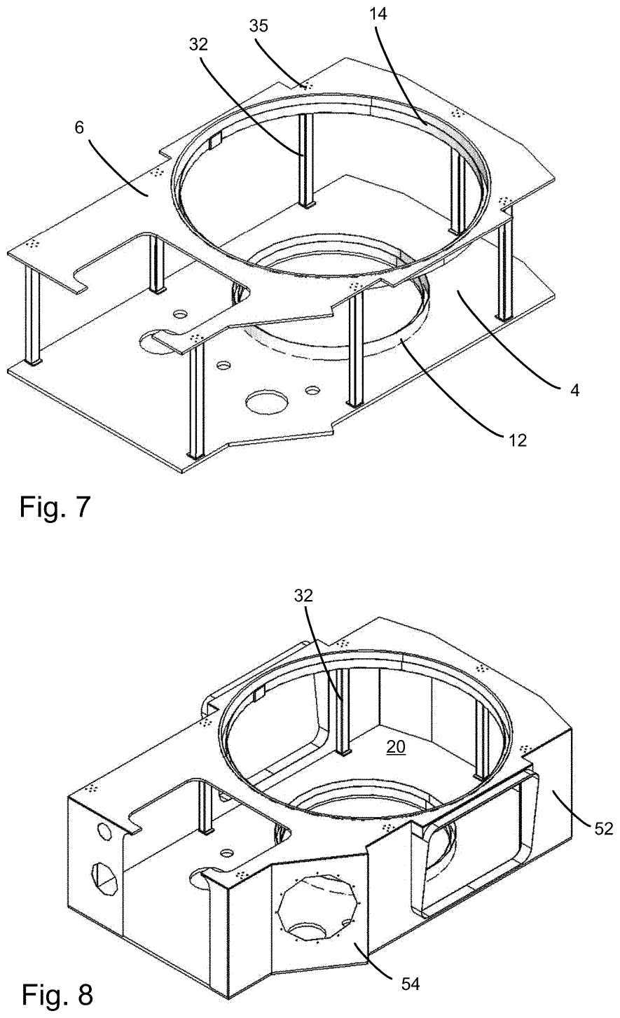

FIG. 7 shows the entire arrangement of the clean room consisting of the floor unit 4, the ceiling unit 6 and the support elements 32 as well as the connections 35. It can be seen here that the sealing device 12 of the floor unit has a smaller cross-section or diameter than the sealing unit 14 which is arranged in the ceiling unit 6.

FIG. 8 shows a further representation of the clean room. Here, additional wall elements 52, 54 are shown, which delimit the clean room from the surroundings. However, these wall elements 52, 54 are not designed as load-bearing elements.

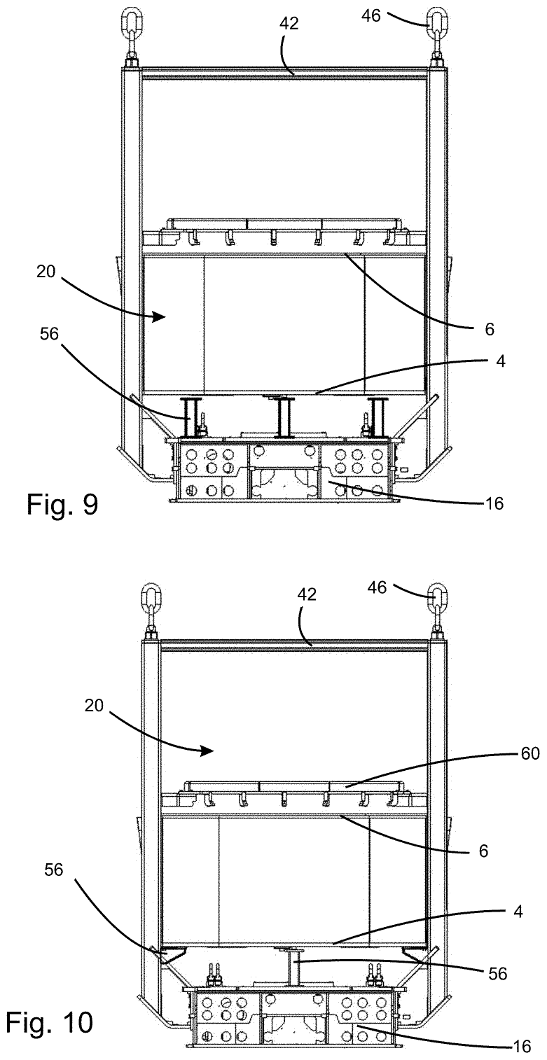

FIG. 9 shows an overall view of the clean room 20, which is arranged on a frame or carrier unit 16. Support elements 56 are provided here to support the cleanroom 20 relative to the carrier unit 16. In addition, the crossbar 42 can also be seen here as described above.

FIG. 10 shows a further illustration, wherein support elements 58 are provided here in the form of angle beams. However, a central carrier 56 is also provided. The reference sign 60 indicates a cross carrier which is used to attach buildings such as valve blocks, stretching rods, drives and the like.

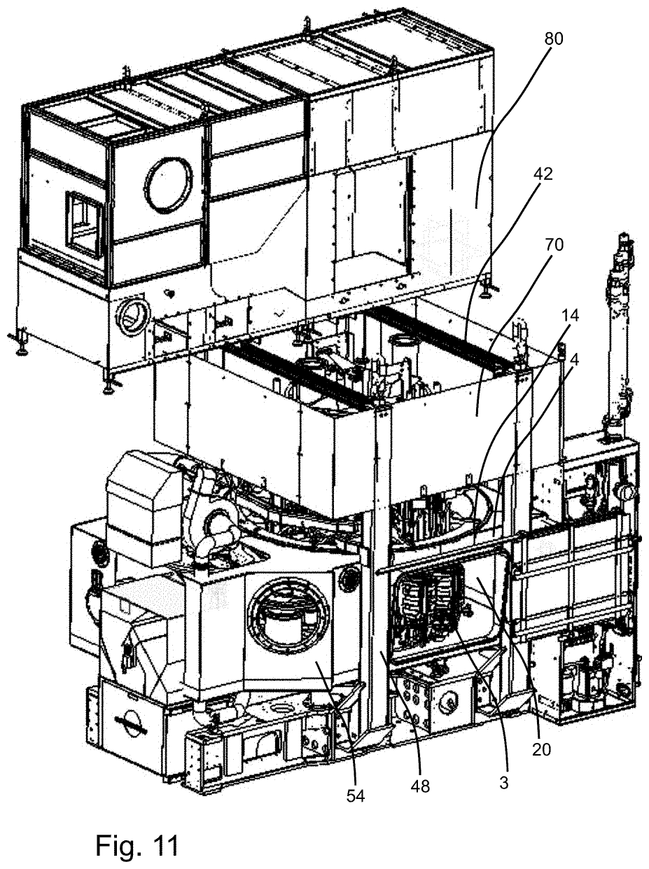

FIG. 11 shows a general view of an apparatus according to the invention. Here, treatment stations 3 are provided in the form of forming stations. The reference sign 20 again indicates the clean room within which these forming stations are guided. In addition, the upper sealing device 14, which is arranged in the ceiling unit 4, can also be seen. The wall elements 54 are also recognisable.

Above the ceiling unit, a further structure 70 is provided in which elements can be integrated, such as stretching bars, drives and the like. This unit is preferably arranged outside the clean room, which is formed between the floor unit and the ceiling unit as mentioned above. Next to it, the crossbar 42 is again visible. This can also be used here to support further units 80 such as a compressed air generation unit or a ventilation unit.

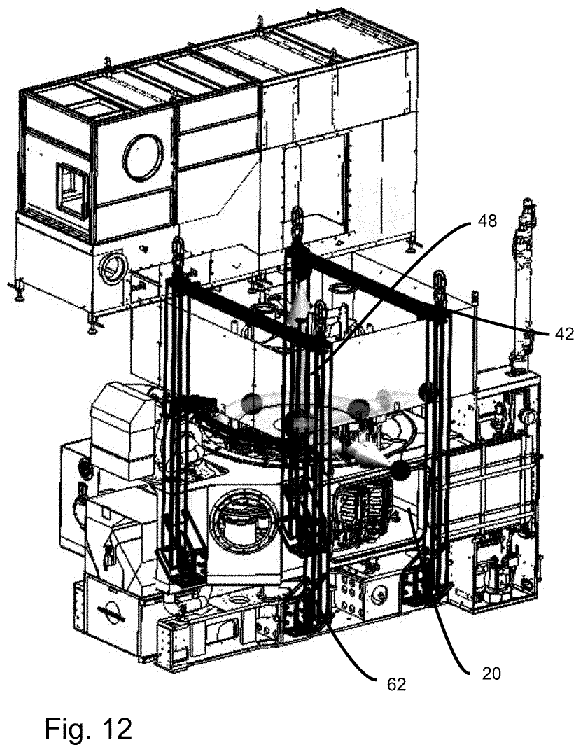

FIG. 12 shows another illustration, in which the support elements are highlighted. It can be seen that longitudinal elements 48 are provided here, which are attached (outside the clean room) to the main carrier or base carrier 16 on the floor. The reference sign 62 indicates fastening devices for fastening the longitudinal elements 48.

The applicant reserves the right to claim all features disclosed in the application documents as essential to the invention, provided that they are individually or in combination new com-pared to the prior art. It is further pointed out that the individual figures also describe features which may be advantageous in themselves. The skilled person immediately recognises that a certain feature described in a figure can also be advantageous without adopting further features from this figure. Furthermore, the skilled person recognises that advantages can also result from a combination of several features shown in individual figures or in different figures.

1. An apparatus for treating containers, having a transport device which transports the containers at least in sections along a predetermined transport path, and having a plurality of treatment devices which treat the containers at least at times during transport along the transport path, wherein the apparatus has a clean room, within which the containers are transported during their treatment, wherein this clean room is delimited from an environment by at least one wall, and furthermore at least one sealing device is provided for sealing off the clean room from its environment, wherein this sealing device has at least two elements and/or walls which are movable with respect to one another
wherein
the clean room is formed between a floor unit and a ceiling unit and at least the floor unit or the ceiling unit is formed as a load-bearing unit and support elements are arranged within the clean room for supporting the ceiling unit and/or the floor unit.

2. An apparatus for treating containers, having a circular or part-circular transport path which is formed by a transport device and on which the containers are moved at least in each case with a partial region having a container opening within a sterile clean room delimited from the surroundings by an enclosure, wherein a partial section of the enclosure is on the transport device and is moved with the latter, and a further subsection of the enclosure is provided on the device frame of the apparatus which is not moved along with the transport device, wherein the enclosure has, at least in the further subsection, a wall structure which is formed by wall elements which delimits the clean room of the wall structure of the enclosure to the surroundings, and of a supporting structure, wherein the elements of the load-bearing structure have a plurality of carriers which are oriented transversely or perpendicularly to a transport direction of the transport device and are fastened at one end by mechanical connections, and in that labyrinth and/or siphon seals are provided at the transition between the sections, and the clean room is formed between a floor unit and a ceiling unit and at least the floor unit or the ceiling unit is formed as load-bearing elements of the load-bearing structure and support elements of the load-bearing structure are arranged inside the clean room for supporting the ceiling unit and/or the floor unit.

3. The apparatus according to claim 1,
wherein
at least one sealing device has a circumferential channel which can be filled with a liquid, wherein this channel is formed in the ceiling unit, and/or at least one sealing device has a circumferential channel which can be filled with a liquid, wherein this channel is formed in the floor unit.

4. The apparatus according to claim 1,
wherein
the floor unit and/or the ceiling unit has a wall thickness of at least 4 mm.

5. The apparatus according to claim 1,
wherein
the support elements are column elements which connect the floor unit to the ceiling unit.

6. The apparatus according to claim 1,
wherein
the clean room is also delimited by side walls, wherein these side walls preferably are of non-load-bearing design.

7. The apparatus according to claim 1,
wherein
the apparatus has a base support on which the floor unit is arranged.

8. The apparatus according to claim 1,
wherein
the apparatus comprises at least one support crossbar.

9. The apparatus according to claim 8,
wherein
the support crossbar connects at least two support elements to each other.

10. The apparatus according to claim 8,
wherein
the support crossbar serves to support further units of the apparatus.

11. The apparatus according to claim 10,
wherein
further units are selected from a group of units comprising guide cams, blowing nozzle cam supports, ceiling supports and ventilation elements.

12. The apparatus according to claim 4,
wherein
the floor unit and/or the ceiling unit has a wall thickness of at least 5 mm.

13. The apparatus according to claim 4,
wherein
the floor unit and/or the ceiling unit has a wall thickness of at least 6 mm.
